(19) United States
(12) Patent Application Publication
(10) Pub. No.: US 2012/0237156 A1
(43) Pub. Date: Sep. 20, 2012

(54) OPTICAL MODULATOR, COMMUNICATION SYSTEM, AND COMMUNICATION METHOD

(75) Inventors: Harald Rohde, Munchen (DE); Erich Gottwald, Holzkirchen (DE)

(73) Assignee: NOKIA SIEMENS NETWORKS OY, Espoo (FI)

(21) Appl. No.: 13/049,287

(22) Filed: Mar. 16, 2011

(51) Int. Cl. G02F 1/035; B23P 17/04

(52) U.S. Cl. 385/3; 29/428

(57) ABSTRACT

An optical modulator has a first branch and a second branch, both being connectable to an input, in particular to a light source. The first branch has an amplitude modulator and a phase shifter, and the amplitude modulator is operable by a first signal that is substantially sinusoidal. The second branch has an amplitude modulator that is operable by a second signal that is substantially 90 degree phase shifted to the first signal. A combining unit with two inputs and two outputs combines the optical fields of the first and second branches. Each output is arranged to supply an optical carrier. A combined optical modulator is formed with at least one such optical modulator. Further, there is provided a method for providing several optical carriers based on an input signal.

### BACKGROUND OF THE INVENTION

### Field of the Invention

The invention relates to an optical modulator and to a combined optical modulator comprising several such optical modulators and to a communication system with at least one optical modulator. Further, the invention also relates to a method for providing optical carriers based on an input signal.

A passive optical network (PON) is a promising approach regarding fiber-to-the-home (FTTH), fiber-to-the-business (FTTB) and fiber-to-the-curb (FTTC) scenarios, in particular as it overcomes the economic limitations of traditional point-to-point solutions.

Several PON types have been standardized and are currently being deployed by network service providers worldwide. Conventional PONs distribute down-stream traffic from the optical line terminal (OLT) to optical network units (ONUs) in a broadcast manner while the ONUs send upstream data packets multiplexed in time to the OLT. Hence, communication among the ONUs needs to be conveyed through the OLT involving electronic processing such as buffering and/or scheduling, which results in latency and degrades the throughput of the network.

In fiber-optic communications, wavelength-division multiplexing (WDM) is a technology which multiplexes multiple optical carrier signals on a single optical fiber by using different wavelengths (colors) of laser light to carry different signals. This allows for a multiplication in capacity, in addition to enabling bidirectional communications over one strand of fiber.

WDM systems are divided into different wavelength patterns, conventional or coarse and dense WDM. WDM systems provide, e.g., up to 16 channels in the 3rd transmission window (C-band) of silica fibers of around 1550 nm. Dense WDM uses the same transmission window but with denser channel spacing. Channel plans vary, but a typical system may use 40 channels at 100 GHz spacing or 80 channels with 50 GHz spacing. Some technologies are capable of 25 GHz spacing. Amplification options enable the extension of the usable wavelengths to the L-band, more or less doubling these numbers.

Optical access networks, e.g., coherent Ultra-Dense Wavelength Division Multiplex (UDWDM) networks, are deemed to be a promising approach for future data access.

Data transmission of spectrally densely spaced wavelengths is utilized by applications as Next Generation Optical Access (NGOA) systems allowing high data rates of, e.g., 100 Gbit/s.

In these optical scenarios, a multitude of optical wavelengths are required in order to be individually modulated. Such optical wavelengths may have a spectral distance of a few gigahertz and can be used either for a ultra dense wavelength grid optical access system like NGOA where each user may be assigned a wavelength of his own or for a transmission of high data rates such as 100 Gbit/s where a multitude of wavelengths are bundled and are transmitted over a small spectral range.

Providing these individual wavelengths by several discrete lasers leads to a huge amount of laser sources that require a significant amount of precision and thus involve high costs. As an alternative, modulating a multitude of single side-bands on an optical carrier also leads to significant costs because of the electronics involved needing to cope with high frequencies required.

### SUMMARY OF THE INVENTION

It is accordingly an object of the invention to provide an optical modulator and a system and method which overcome a variety of disadvantages of the heretofore-known devices and methods of this general type and which provides for an efficient solution for providing a multitude of optical wavelengths at a spectral distance of, say, a few GHz.

With the foregoing and other objects in view there is provided, in accordance with the invention, an optical modulator, comprising:

a first branch and a second branch each connectable to an input, in particular to a light source;

the first branch containing an amplitude modulator and a phase shifter, the amplitude modulator in the first branch being operable by a substantially sinusoidal first signal;

the second branch containing an amplitude modulator that is operable by a second signal that is phase-shifted by substantially 90 degrees relative to the first signal;

a combining unit having two inputs and two outputs and combining the optical fields of the first branch and the second branch;

each of the outputs being arranged to supply an optical carrier.

With the optical modulator branches being electrically modulated by substantially sinusoidal signals, the optical modulator provides optical carriers at a predetermined frequency offset to the frequency of the light source. These optical carriers can be further modulated with (electrical) data signals and the modulated data signals can be transmitted via an optical fiber. Also the optical carriers could be processed, e.g., split, into further optical carriers, in particular by an assembly of cascaded or combined optical modulators.

The amplitude modulator modulates the electromagnetic field of the optical signal proportional to the control signal (i.e. the first signal) and the phase shifter provides a phase switching of 180-degree at the zero-crossing of the optical signal.

An output of the combining unit contains the same modulated data as does the other output of the combining unit, but on the opposite spectral side of the carrier signal provided by the light source (different offsets with regard to the carrier signal).

The amplitude modulators of the first branch and the second branch preferably operate at the same frequency thereby providing a carrier signal that is offset by this frequency from the input signal of the light source. Advantageously, this approach allows generating two carriers based on the input signal's carrier. The carriers can be flexibly adjusted based on the frequencies of the amplitude modulators.

It is noted that the substantially sinusoidal signal may comprise an amplitude modulation with a modulation index amounting to less than 10% and a modulation frequency amounting to less than 10 MHz. The substantially sinusoidal signal may also comprise a frequency modulation with a modulation frequency amounting to less than 10 MHz.

In accordance with another embodiment of the invention, the optical modulator comprises a two-beam interferometer.

In another embodiment, the first branch and the second branch of the optical modulator each comprises a Mach-Zehnder modulator. The Mach-Zehnder modulator (MZM) allows for a control of the first branch opposite in phase with the second branch of the optical modulator.

In a further embodiment, a phase of the first branch or a phase of the second branch is adjusted to at least partially compensate a deficient suppression of the frequency of the light source. Hence, the optical modulator can be adjusted such that the carrier is in principle completely eliminated. As the degree of carrier elimination may be limited by the imperfect symmetry of the interferometer arms, a slight misadjustment of the phase bias in a modulator branch, in particular the branch with the better extinction ratio, can be provided.

In accordance with a further embodiment, each output of the combining unit is modulated with an electrical data signal into an optical output signal that is combined and conveyed via an optical fiber. Hence, the output of the combining unit provides an optical carrier that can be modulated with an electrical data signal at the baseband. It is noted that such electrical data signal may itself comprise a modulated data signal with at least two carriers.

It is also an embodiment that each output of the combining unit is conveyed via a splitter to a modulator and further to a polarization converter and the polarized output signal is combined and conveyed via an optical fiber. This approach thus enables polarization multiplex, in particular by utilizing λ/4 polarization converters.

In accordance with an added feature of the invention, the optical modulator comprises a third output that provides the signal of the input. Hence, the signal of the input can be utilized in particular in a cascaded structure of optical modulators for further processing.

In accordance with an advantageous embodiment of the invention, the optical modulator supplies local oscillator signals in an optical component, in particular in an optical line terminal.

According to another embodiment, each output of the optical modulator is connected to a receiver of the optical component. Hence, the carrier signals provided by the optical modulator can be used as local oscillator signals at the optical component, in particular to demodulate data signals that are received via an optical fiber.

In particular, several parallel and/or cascaded optical modulators can be used in such optical component to provide a required number of optical carriers at suitable frequencies, based on, e.g., a single light source.

With the above and other objects in view there is also provided, in accordance with the invention, a combined optical modulator comprising several optical modulators as described herein. The several optical modulators are fed via a common light source.

Such light source may provide an optical carrier that is conveyed to the several optical modulators via a splitter. The optical modulators are arranged in parallel and supply several carriers that could be used for being modulated with data signals to be conveyed via a single optical fiber.

The problem stated above is also solved by a combined optical modulator comprising several optical modulators as described herein, wherein a first output of a first optical modulator is connected to an input of a second optical modulator and a second output of the first optical modulator is connected to an input of a third optical modulator.

Hence, the optical modulators can be arranged in sequence (cascaded) to each other thereby providing several carriers at various offsets with regard to the frequency of the light source.

It is noted that the several optical modulators may operate at different frequencies in order to obtain a grid of optical carriers that are suitably spaced from each other.

It is in particular an option to combine the parallel and the serial arrangement of optical modulators as described herein in order to obtain a combined optical modulator.

Hence, the optical modulators described herein can be arranged in parallel and/or in sequence to each other. A single light source may be fed to several optical modulators and the output of each optical modulator may be fed to at least one input of another optical modulator and so forth. This allows generating a grid of optical carriers with a desired spacing, wherein each of the optical carriers can be used to be modulated with a data signal and the modulated signal can be fed to a combiner and be conveyed across an optical fiber.

The problem stated above is further solved by a communication system comprising at least one optical modulator as described herein or at least one combined optical modulator as also described herein.

With the above and other objects in view there is also provided, in accordance with the invention, a method for providing several optical carriers based on an input signal,

wherein the input signal is fed by a splitter to a first branch and to a second branch;

wherein the input signal is modulated and phase shifted by the first branch, wherein the input signal is amplitude modulated by a first signal that is substantially sinusoidal;

wherein the input signal is amplitude modulated by a second signal in the second branch, wherein the second signal is substantially 90 degree phase shifted to the first signal;

wherein the optical fields of the first branch and the second branch are combined by a combining unit, which supplies two outputs,

wherein each output provides an optical carrier.

An output of the combining unit contains the same modulated data as does the other output of the combining unit, but on the opposite spectral side of the carrier signal provided by the input signal (different offsets with regard to input's carrier).

It is noted that the features described with regard to the devices above are applicable for the method in an analogous manner. It is in particular an option to provide several optical carriers that are utilized as local oscillators for demodulation purposes in an optical component, e.g., in an OLT.

It is another embodiment that each output of the combining unit is modulated with an electrical signal and in particular such modulated signal is fed via a combiner onto an optical fiber.

Other features which are considered as characteristic for the invention are set forth in the appended claims.

Although the invention is illustrated and described herein as embodied in an optical modulator, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows an optical modulator that supplies optical carriers relative to a frequency of a light source input to the optical modulator;

FIG. 2 shows a schematic block diagram comprising an exemplary optical multi-channel generator;

FIG. 3 shows a schematic diagram, wherein the structure of FIG. 2 is extended to provide polarization multiplex (PolMux);

FIG. 4 shows an alternative block structure of an optical multi-channel generator providing six carriers;

FIG. 5 shows another schematic block structure of an optical multi-channel generator providing 14 carriers;

FIG. 6 shows a further schematic block structure of an optical multi-channel generator with a parallel structure providing eight carriers;

FIG. 7 shows a schematic diagram comprising a four channel transceiver to be used in an OLT, wherein the transceiver comprises the optical multi-channel generator as shown in FIG. 2; and

FIG. 8 shows a more generalized structure as FIG. 1. Instead of the MZM mentioned, different modulator schemes may apply as indicated by two modulator branches.

### DETAILED DESCRIPTION OF THE INVENTION

It is in particular suggested to use both outputs of a single sideband modulator (SSBM), wherein several such modulators could be connected in series or in parallel such that based on an input from a single light source (i.e. a single carrier) several carriers (frequencies) could be generated that are spaced apart from each other by, e.g., only a few gigahertz. These frequencies (or wavelengths) could be individually modulated and thus utilized for NGOA systems or UDWDM networks.

The SSBM could be realized as a two-beam interferometer, e.g., a Michelson interferometer, in particular by a Mach-Zehnder Modulator (MZM).

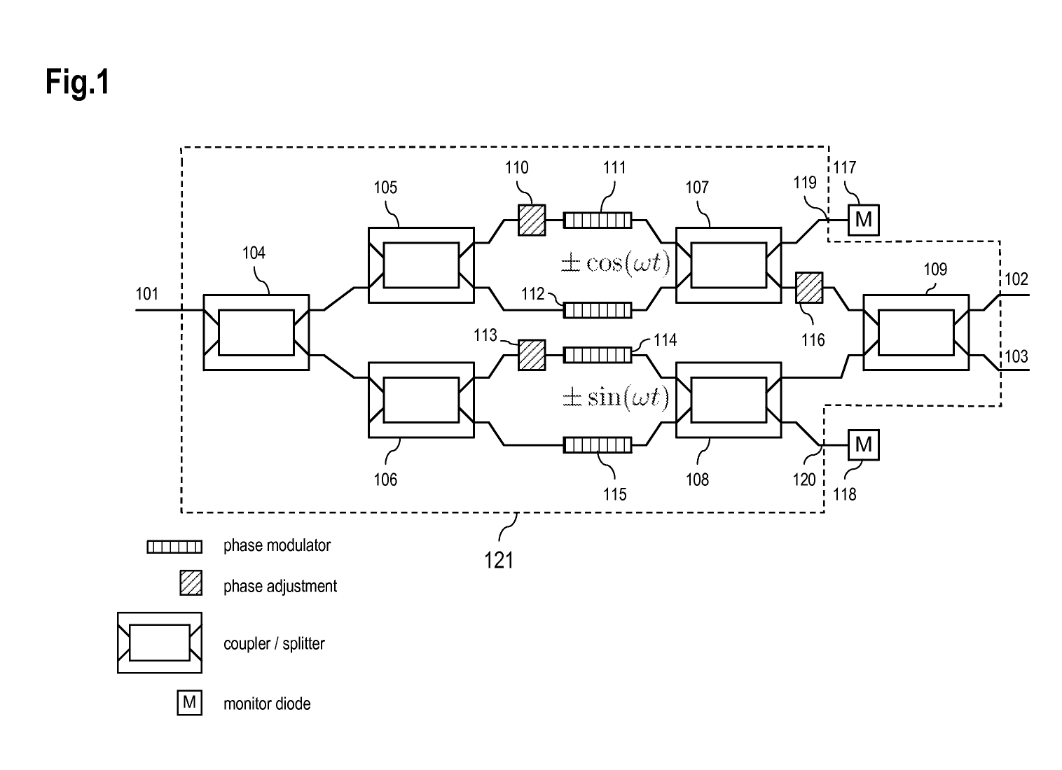

Referring now to the figures of the drawing in detail and first, particularly, to FIG. 1 thereof, there is shown a modulator structure comprising a coupler 104 (also referred to as a splitter) to which an input signal (light) 101 is fed. The coupler 104 is further connected to a coupler 105 and to a coupler 106, thereby conveying the input signal 101.

The coupler 105 conveys the incoming light via a phase adjustment 110 and a phase modulator 111 to a coupler 107 and also directly via a phase modulator 112 to said coupler 107.

Accordingly, the coupler 106 conveys the incoming light via a phase adjustment 113 and a phase modulator 114 to a coupler 108 and also directly via a phase modulator 115 to said coupler 108.

The output of the coupler 107 is fed via a terminal 119 to a monitor diode 117 and via a phase adjustment 116 to a coupler 109. The output of the coupler 108 is fed via a terminal 120 to a monitor diode 118 and to the coupler 109.

The coupler 109 provides two output signals 102 and 103. The modulator unit with its input and output ports 101, 102, 103, 119 and 120 is also depicted as a block 121, which will be used as such in the figures below.

The output signal 103 contains the same modulated data as does the output signal 102, but on the opposite spectral side of the carrier signal 101.

The modulator 121 is driven at a frequency ω, e.g., 5 GHz. The light of the output signal 102 is offset by +5 GHz and the light of the output signal 103 is offset by −5 GHZ from the carrier frequency.

As the driving signals are single frequencies, both the driving circuit and the electrode structure can be tailored to the respective frequency (e.g., by using resonant circuits), thus easing the requirements for the electronics.

The modulator 121 can be adjusted such that the carrier is in principle completely eliminated. In practice, without additional measures, the degree of carrier elimination is limited by the symmetry of the interferometer arms visible in a finite extinction ratio if the modulator is used as an amplitude modulator. A counter measurement against poor carrier suppression caused by poor symmetry of the modulator can be a slight misadjustment of the phase bias in the modulator arm with better extinction ratio.

The carrier is directed to the outputs which contain the monitor diodes 117, 118, which can be used for adequate adjustment of the bias phases. The carrier can, in some cases, also be used for further processing purposes.

To avoid strong distortions by harmonics, the best compromise between SSB generation efficiency and low harmonics seems to be a modulation depth of about 90° to 110° resulting in an efficiency of about 30%.

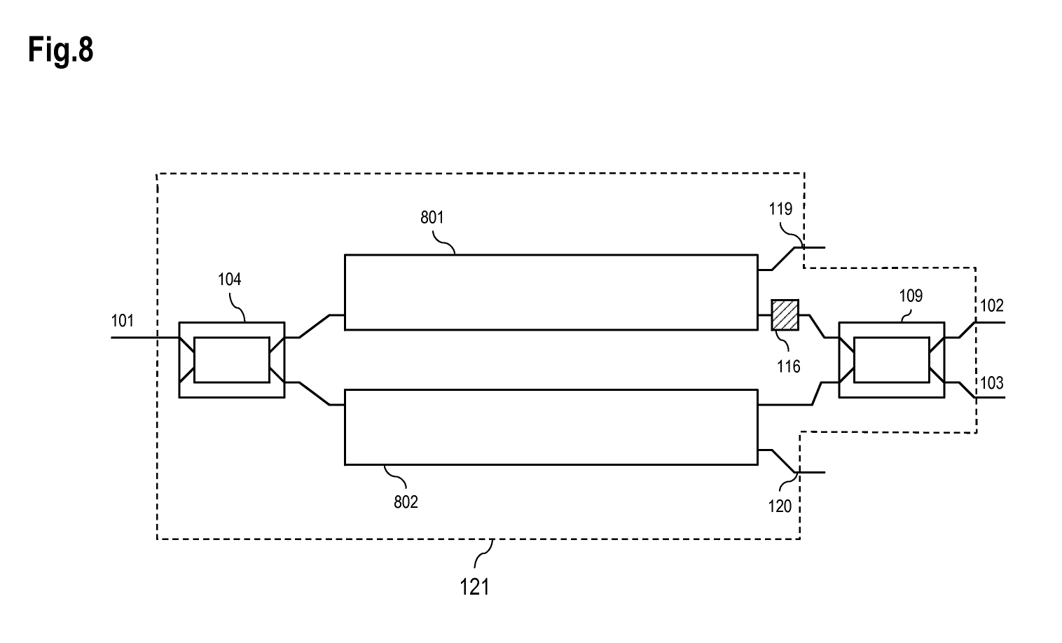

FIG. 8 shows a more generalized structure as FIG. 1. Instead of the MZM mentioned, different modulator schemes may apply as indicated by blocks 801 and 802.

A first branch 801 provides an amplitude modulation with a first signal. The first signal is substantially sinusoidal. In addition, the first branch provides a phase shift, i.e., a 180-degree phase shift at the zero-crossing of the optical signal. A second branch 802 provides an amplitude modulation with a second signal. The second signal is substantially 90-degree phase shifted compared to the first signal. For example, the first signal may be a sinus with a predefined frequency and the second signal may be a cosine with the same frequency. Due to the phase adjustment 116, the signals that are fed to the coupler 109 have an optical phase difference of (substantially) 90 degrees.

It is noted that hereinafter the modulator 121 may realized as shown and explained in FIG. 1 or FIG. 8.

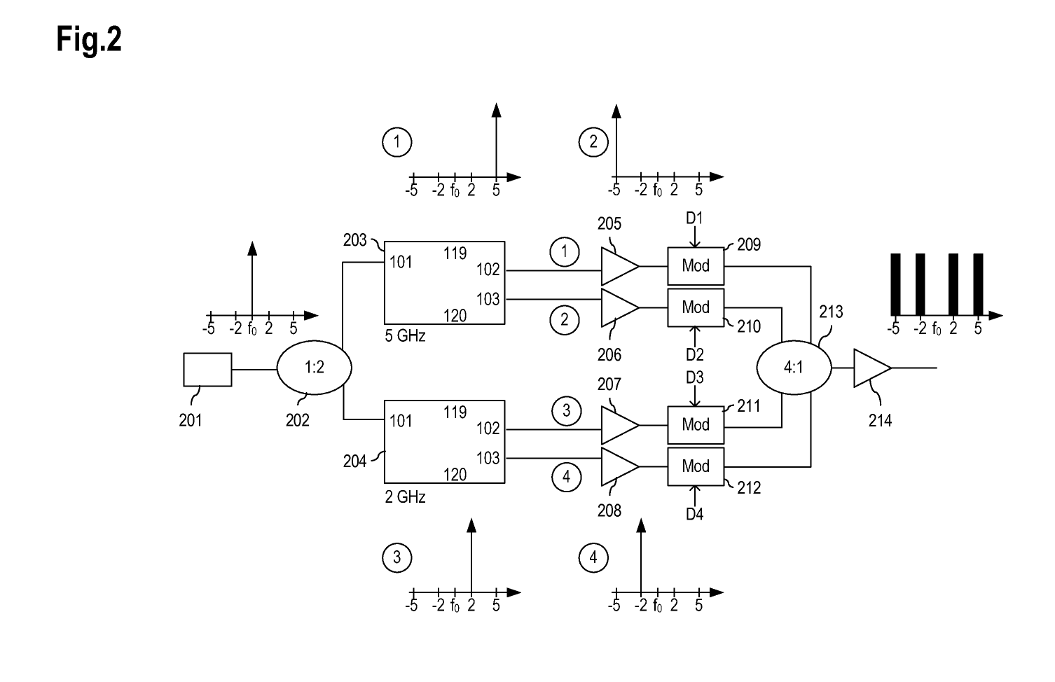

FIG. 2 shows a schematic block diagram comprising an exemplary optical multi-channel generator.

A single mode laser 201 feeds an optical signal via a splitter 202 to a modulator 203 and to a modulator 204. Each of the modulators 203 and 204 corresponds to the modulator 121 as shown in FIG. 1. The modulator 203 operates at a frequency of 5 GHz and the modulator 204 operates at a frequency of 2 GHz.

The output signal of the modulator 203 provides a frequency with an offset of 5 GHz, which is fed via an optical amplifier 205 to a modulator 209 where it is modulated with a data signal D1. The output of the modulator 209 is conveyed to a combiner 213. Accordingly, another output signal of the modulator 203 provides a frequency with an offset of −5 GHz, which is fed via an optical amplifier 206 to a modulator 210 where it is modulated with a data signal D2. The output of the modulator 210 is conveyed to the combiner 213.

Also the output signal of the modulator 204 provides a frequency with an offset of 2 GHz, which is fed via an optical amplifier 207 to a modulator 211 where it is modulated with a data signal D3. The output of the modulator 211 is conveyed to the combiner 213. Accordingly, another output signal of the modulator 203 provides a frequency with an offset of −2 GHz, which is fed via an optical amplifier 208 to a modulator 212 where it is modulated with a data signal D4. The output of the modulator 212 is conveyed to the combiner 213.

The output of the combiner 213 is fed to an optical amplifier 214.

Hence, the modulator 203 generates two wavelengths with an offset of 5 GHz and −5 GHz from the carrier, i.e. the frequency of the single mode laser 201. The modulator 204 generates two wavelengths with an offset of 2 GHz and −2 GHz from the carrier. Each of the four outputs from the modulators 203 and 204 is then individually modulated with a data signal D1 to D4 at the data baseband and the four modulated signals are combined for transmission purposes.

The optical amplifiers 205 to 208 and 214 can be included in the structure; their dimensioning may in particular depend on the optical power budget.

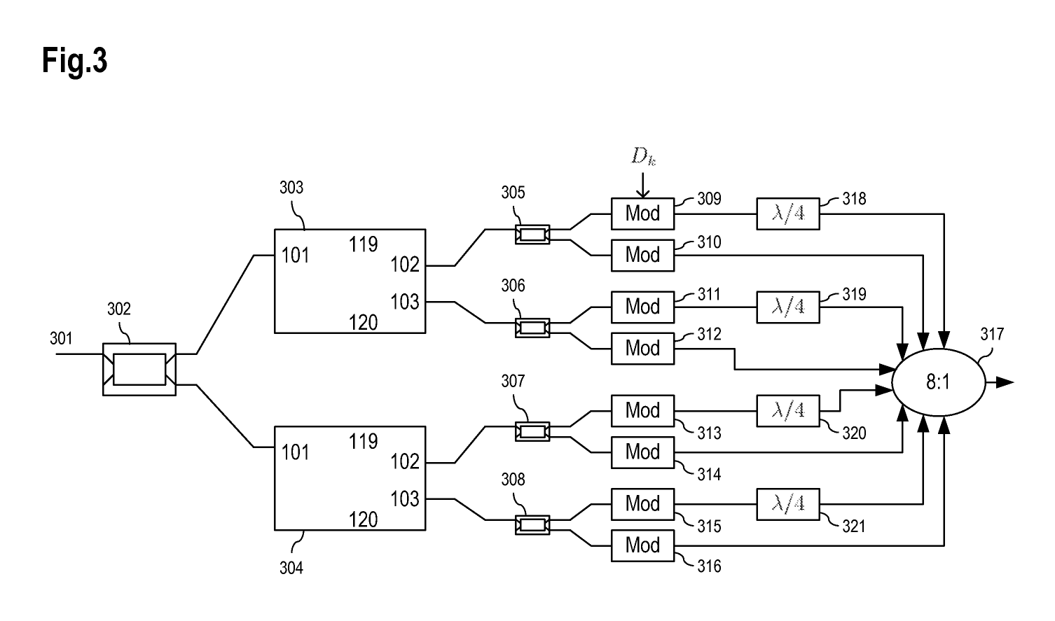

FIG. 3 shows a schematic diagram, wherein the structure of FIG. 2 is extended to provide polarization multiplex (PolMux).

An optical signal 301 is fed to a splitter 302 and further to a modulator 303 and to a modulator 304. Each of the modulators 303 and 304 corresponds to the modulator 121 as shown in FIG. 1.

The output signals of the modulator 303 are fed via splitters 305, 306 to modulators 309 to 312 where they are is modulated with data signals Dₖ (k=1 . . . 4). Each output of the modulators 309, 311 is conveyed via a λ/4 polarization converter 318, 319 to a combiner 317 and each output of the modulators 310, 312 is directly conveyed to the combiner 317.

Accordingly, output signals of the modulator 304 are fed via splitters 307, 308 to modulators 313 to 316 where they are is modulated with data signals Dₖ (k=5 . . . 8). Each output of the modulators 313, 315 is conveyed via a λ/4 polarization converter 320, 321 to the combiner 317 and each output of the modulators 314, 316 is directly conveyed to the combiner 317.

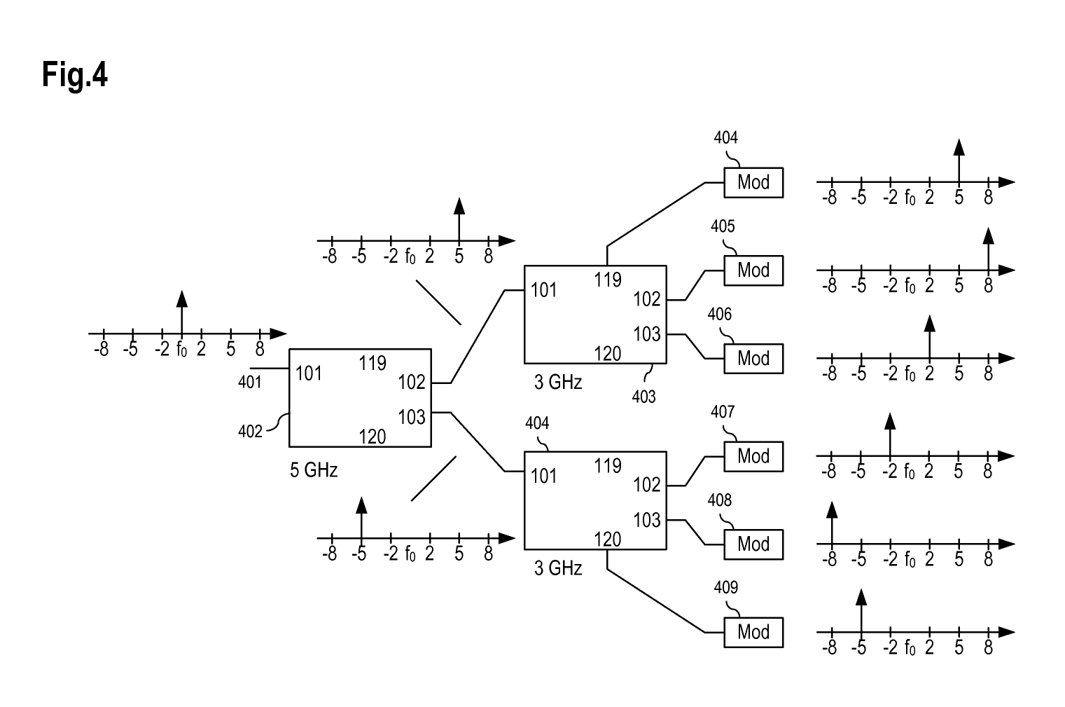

FIG. 4 shows an alternative block structure of an optical multi-channel generator providing six carriers.

An optical signal 401 is fed to a modulator 402 and further to a modulator 403 and to a modulator 404. Each of the modulators 402 to 404 corresponds to the modulator 121 as shown in FIG. 1. The modulator 402 operates at a frequency of 5 GHz and the modulators 403, 404 each operates at a frequency of 3 GHz.

The output of the modulators 403 and 404 provides the carrier frequencies as shown on the right hand side, i.e. amounting to 5 GHz, 8 GHz, 2 GHz, 2 GHz, −8 GHz and −5 GHz relative to the frequency f₀ of the carrier frequency provided by the optical signal 401.

Each output signal of the modulators 403 and 404 is modulated with data signals (not shown in FIG. 4) via modulators 404 to 409.

Both the parallel and the cascaded solution can be combined for a higher number of carrier frequencies to be provided. Also polarization multiplex could be combined if required.

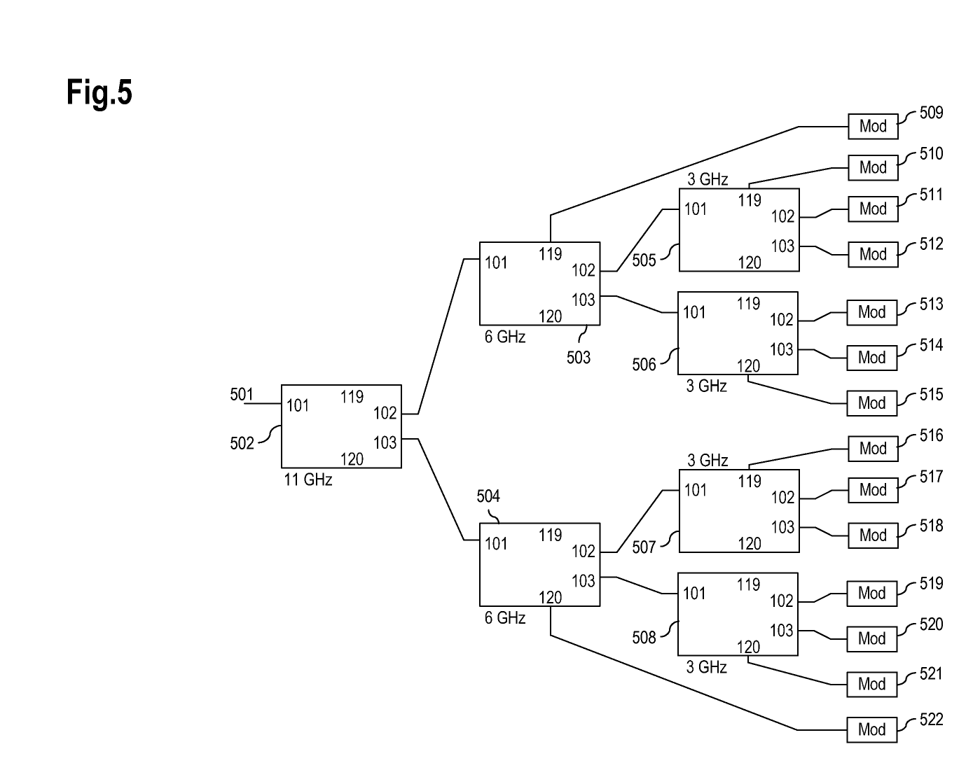

FIG. 5 shows another schematic block structure of an optical multi-channel generator providing 14 carriers.

An optical signal 501 is fed to a modulator 502, next to a modulator 503 and to a modulator 504 and further to modulators 505 to 508. Each of the modulators 502 to 508 corresponds to the modulator 121 as shown in FIG. 1. The modulator 502 operates at a frequency of 11 GHz, the modulators 503, 504 each operates at a frequency of 6 GHz and the modulators 505 to 508 each operates at a frequency of 3 GHz.

The output of the modulators provides carrier frequencies amounting to 11 GHz, 17 GHz, 20 GHz, 14 GHz, 8 GHz, 2 GHz, 5 GHz and −11 GHz, −17 GHz, −20 GHz, −14 GHz, −8 GHz, −2 GHz, −5 GHz relative to the frequency f_{c}, of the carrier frequency provided by the optical signal 501.

The output signals of the modulators are modulated with data signals (not shown in FIG. 5) via modulators 509 to 522.

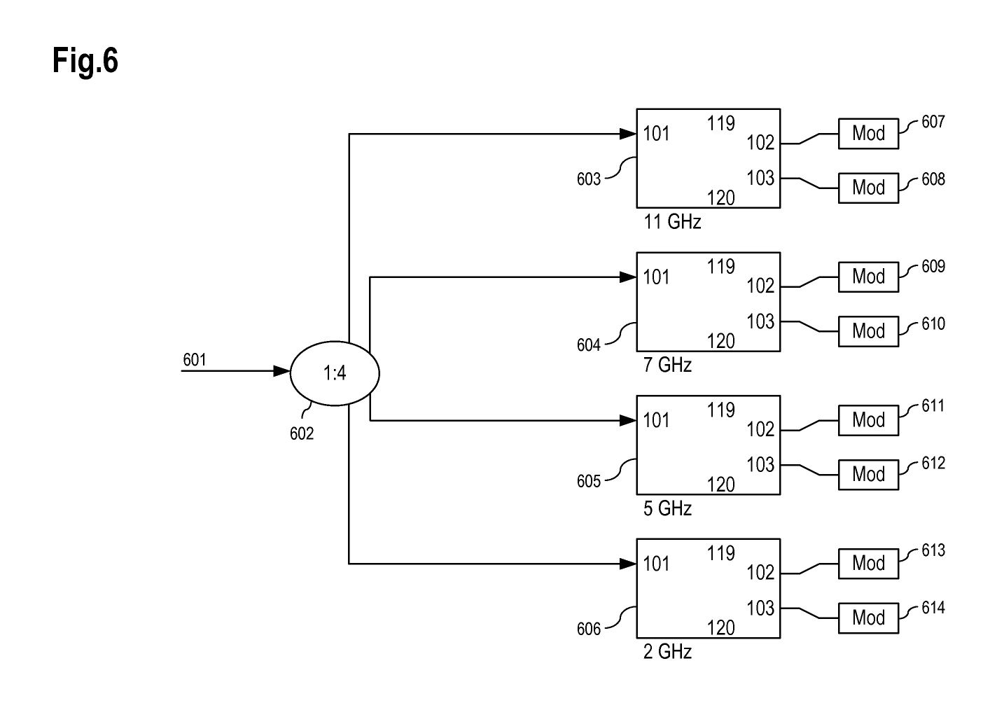

FIG. 6 shows a further schematic block structure of an optical multi-channel generator with a parallel structure providing 8 carriers.

An optical signal 601 is fed to a 1:4 splitter 602 and further to a modulator 603 with an operating frequency of 11 GHz, to a modulator 604 with an operating frequency of 7 GHz, to a modulator 605 with an operating frequency of 5 GHz and to a modulator 606 with an operating frequency of 2 GHz. Each of the modulators 603 to 606 corresponds to the modulator 121 as shown in FIG. 1.

The output signals of the modulators 603 to 606 are modulated with data signals (not shown in FIG. 6) via modulators 607 to 614.

It is noted that the combining of the data signal-modulated wavelengths is not shown in FIG. 4 to FIG. 6 for legibility reasons. However, as a final stage (according to the FIG. 2 and FIG. 3), a combiner can be provided that conveys all wavelengths onto a single fiber.

It is further noted that as an option, optical amplifiers may be supplied for power regeneration purposes. Such optical amplifiers may be provides as SOAs (semiconductor optical amplifiers) allowing integration of all the structures in InP.

It is also an option that the modulation signal which is modulated onto the generated wavelengths comprises several n sub-carriers itself, thus multiplying the number of wavelengths generated by the whole transmitter by n.

This can be achieved using the MZM (or a Michelson interferometer based, in general a two-way interferometer based IQ modulator) by applying electrical signals Dₖ as depicted in FIG. 2 or in FIG. 3 with two ore more signals in a baseband and additional electrical carriers. Preferably, a total phase modulation index may not exceed a value leading to a high harmonic generation, in case of a simple design without electronic pre-distortion the total modulation index may be below 110°.

A numeric example for generating eight wavelengths with frequency offsets compared to a carrier laser source according to FIG. 2 is as follows: Driving the modulator 203 with a frequency amounting to 0.5 GHz and the modulator 204 with a frequency amounting to 6.5 GHz delivers frequency offsets of ±0.5 GHz and ±6.5 GHz at the outputs of the modulators 203, 204. Using carriers at the data modulation portion amounting to 1.5 GHz and 4.5 GHz an output of optical carriers may amount to ±2 GHz, ±5 GHz, ±8 GHz and ±11 GHz.

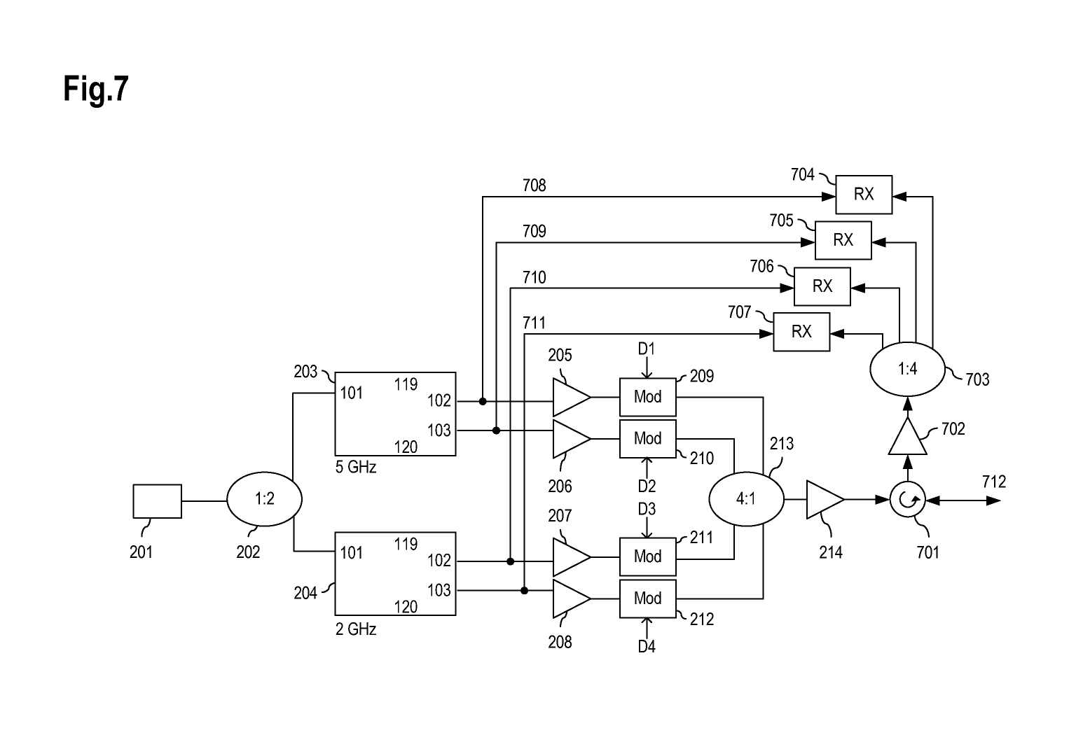

FIG. 7 shows a schematic diagram comprising a four channel transceiver to be used in an OLT. The transceiver comprises the optical multi-channel generator as shown in FIG. 2.

In addition to FIG. 2, the output of the optical amplifier is fed to a circulator 701, which is also connected to a fiber 712. Further, the circulator 702 is connected via an optical amplifier 702 to a 1:4 splitter 703 conveying incoming signals towards receivers 704 to 707.

Each of the receivers 704 to 707 receives an optical local oscillator signal 708 to 711, which is supplied by the optical multi-channel generator. Hence, the optical multi-channel generator is used for modulating the outgoing data signals D1 to D4 and for demodulating incoming signals conveyed to the receivers 704 to 707.

This approach also reduces electrical requirements at the coherent receiver by using a multi-wavelength optical local oscillator with multiple optical outputs each carrying one wavelength. A single local oscillator wavelength 704 to 707 is used for selection and demodulation of one optical channel or a subset of optical channels.

### Further Advantages:

The solution provided could be applied to, e.g., 100 G systems. The combination of four wavelengths, polarization multiplex and DQPSK results in 4×2×6.25 Gsymbols/s which corresponds to 100 Gb/s. In this arrangement the data processing speed, respectively the bandwidth of electrical circuitry, analog-to-digital converters and digital-to analog-converters may cope with a processing speed of 6.25 Gb/s, which is a significant reduction for a 100 G solution.

Hence, the solution requires less bandwidth for electrical circuitry, in particular with regard to analog-to-digital converters and digital-to-analog converters in case of digital processing.

The concept suggested is highly scalable to flexibly provide an appropriate number of wavelengths.

The costs of the overall system could be reduced by optimizing the number of optical components required (i.e. the chip-size) in view of electrical bandwidth requirements.

### List of Acronyms:

### DQPSK Differential QPSK

### HF High Frequency

### MZM Mach-Zehnder Modulator

### NGOA Next Generation Optical Access

### OLT Optical Line Terminal

### PolMux Polarization Multiplex

### PSK Phase Shift Keying

### QPSK Quadrature PSK

### SSB Single Sideband

### SSBM SSB Modulator

### ONU Optical Network Unit

### PON Passive Optical Network

### FTTH Fiber-to-the-Home

### FTTB Fiber-to-the-Business

### FTTC Fiber-to-the-Curb

### WDM Wavelength Division Multiplexing

UDWDM Ultra Dense WDM

1. An optical modulator, comprising:
a first branch and a second branch each connectable to an input;
said first branch containing an amplitude modulator and a phase shifter, said amplitude modulator in said first branch being operable by a substantially sinusoidal first signal;
said second branch containing an amplitude modulator that is operable by a second signal that is phase-shifted by substantially 90 degrees relative to the first signal;
a combining unit having two inputs and two outputs and combining the optical fields of said first branch and said second branch;
each of said outputs being arranged to supply an optical carrier.

2. The optical modulator according to claim 1, wherein said first and second branches are each connectable to a light source.

3. The optical modulator according to claim 1, comprising a two-beam interferometer.

4. The optical modulator according to claim 1, wherein said first branch and said second branch each comprises a Mach-Zehnder modulator.

5. The optical modulator according to claim 2, wherein a phase of said first branch or a phase of said second branch is adjusted to at least partially compensate a deficient suppression of a frequency of said light source.

6. The optical modulator according to claim 1, wherein each output of said combining unit is modulated with an electrical data signal into an optical output signal that is combined and conveyed via an optical fiber.

7. The optical modulator according to claim 1, which comprises a splitter connected to said output of said combining unit, a modulator connected to said splitter, and a polarization converter connected to said modulator, said polarization converter outputting a polarized output signal, and wherein the polarized output signal is combined and conveyed via an optical fiber.

8. The optical modulator according to claim 7, wherein said optical modulator comprises a third output carrying the signal of the input.

9. The optical modulator according to claim 1, configured to supply local oscillator signals in an optical component.

10. The optical modulator according to claim 9, configured to supply local oscillator signals in an optical line terminal.

11. The optical modulator according to claim 9, wherein each output of the optical modulator is connected to a receiver of the optical component.

12. A combined optical modulator, comprising a plurality of optical modulators each according to claim 1, disposed to receive a feed signal from a common light source.

13. A combined optical modulator, comprising a plurality of optical modulators each according to claim 1, said plurality of optical modulators including a first optical modulator, a second optical modulator, and a third optical modulator, said first optical modulator having a first output connected to an input of said second optical modulator and a second output connected to an input of said third optical modulator.

14. A combined optical modulator, comprising:
at least one combined optical modulator comprising a plurality of optical modulators each according to claim 1, disposed to receive a feed signal from a common light source; and
at least one combined optical modulator comprising a plurality of optical modulators each according to claim 1, said plurality of optical modulators including a first optical modulator, a second optical modulator, and a third optical modulator, said first optical modulator having a first output connected to an input of said second optical modulator and a second output connected to an input of said third optical modulator.

15. A communication system, comprising at least one optical modulator according to claim 1.

16. A communication system, comprising at least one combined optical modulator formed of a plurality of optical modulators each according to claim 1 and disposed to receive a feed signal from a common light source.

17. A communication system, comprising at least one combined optical modulator formed of a plurality of optical modulators each according to claim 1 and disposed to receive a feed signal from a common light source, and at least one combined optical modulator formed of a plurality of optical modulators each according to claim 1 and including first, second, and third optical modulators, said first optical modulator having a first output connected to an input of said second optical modulator and a second output connected to an input of said third optical modulator.

18. A method for providing a plurality of optical carriers based on an input signal, the method which comprises:
feeding an input signal by a splitter to a first branch and to a second branch;
modulating and phase-shifting the input signal by the first branch, thereby amplitude-modulating the input signal by a first, substantially sinusoidal signal;
amplitude-modulating the input signal by a second signal in the second branch, wherein the second signal is phase-shifted by substantially 90 degrees relative to the first signal;
combining the optical fields of the first branch and the second branch by a combining unit, wherein the combining unit supplies two outputs; and
wherein each of the outputs provides an optical carrier.

19. The method according to claim 18, which comprises modulating each output of the combining unit with an electrical signal.

20. The method according to claim 18, which comprises modulating each output of the combining unit with an electrical signal to form a modulated signal, and feeding the modulated signal via a combiner onto an optical fiber.
